(19) United States
(12) Patent Application Publication
(10) Pub. No.: US 2002/0026738 A1
(43) Pub. Date: Mar. 7, 2002

(54) Peel-off/break structure of display label

(76) Inventors: Mitsuo Shiga, Wako-shi (JP); Hayato Matsuda, Wako-shi (JP)

Correspondence Address: ARENT FOX KINTNER PLOTKIN & KAHN, PLLC, Suite 600, 1050 Connecticut Avenue, N.W., Washington, DC, 20036-5339, US

(21) Appl. No.: 09/880,095

(22) Filed: Jun. 14, 2001

(30) Foreign Application Priority Data
Jun. 16, 2000 (JP) 2000-185901

(51) Int. Cl. G09F 3/04

(52) U.S. Cl. 40/630

(57) ABSTRACT

A peel-off/break structure of a display label is designed so that it is broken during peeling-off in order to prevent the display label from being peeled off and reused. The display label can be broken during peeling-off, irrespective of an adhesive force of the display label to a surface, and thus prevented from being reused. Weakened portions are provided on a display label having a self-adhesive applied to its back at points spaced inwards apart from an outer peripheral edge of the display label, so that a breaking force is concentrated, when a peeling-off force is applied to the display label affixed to a surface. The weakened portions are comprised of a plurality of cut lines made in a connected pattern to extend in directions intersecting one another.

### BACKGROUND OF THE INVENTION

1. Field of the Invention

The present invention relates to an improvement in a peel-off/break structure of a display label designed to be broken during peeling-off, in order to prevent the display label from being peeled-off and reused.

2. Description of the Prior Art

For a common display label, it is conventionally required that the display label can be affixed beautifully, and when the duty of the display label has been finished, the display label can be peeled off easily and clearly. For example, Japanese Utility Model Laid-open No. 7-1660 discloses the structure of a display label designed to be easily reused, and Japanese Utility Model Application Laid-open No. 5-38672 discloses the structure of a display label, which is designed to be peeled off in a simple manner, when a packing is unsealed, so that the display label does not obstruct the unsealing.

On the other hand, when a display label is required to be prevented from being peeled off and reused, such as an identifying label, it is required that the display label can be affixed beautifully, and when the display label has been peeled off, it can be prevented from being restored to its original state and reused. For this purpose, the material itself for forming the display label is conventionally provided with a weakness so that the display label is broken during peeling-off.

With a display label formed of a material having a weakness as in the above prior art, it is required that the adhesive strength of the display label to an adhered surface, is larger than the breaking strength thereof. In some display labels, however, the adhesive strength may be smaller than the breaking strength, depending on the adhered surface. For example, when a display label must be adhered to a part made of a synthetic resin which is granulated on its surface, the adhesive strength may be smaller than the breaking strength of the display label and for this reason, when the display label is peeled off, a situation in which the display label is not broken may arise. In order to enable a seal printing at a low cost in place of a screen-printing at a high cost, a display label subjected to a surface lamination is used in many cases. Such a display label is reinforced by a laminate film and hence, is difficult to break.

### SUMMARY OF THE INVENTION

The present invention has been accomplished with the above circumstance in view, and it is an object of the present invention to provide a peel-off/break structure of a display label, which is designed so that it is broken reliably during peeling-off, irrespective of the adhesive strength to the surface to which it is adhered, whereby the display label can be prevented from being reused.

To achieve the above object, there is provided a peel-off/break structure of a display label, comprising weakened portions, each of which are comprised of a plurality of cut lines made in a connected shape or pattern to extend in directions to intersect one another. The cut lines are provided on the display label having prints on its surface and a self-adhesive applied on its back at points spaced inwards from an outer peripheral edge of the display label, so that when a peeling-off force is applied to the display label adhered to a surface, a breaking force depending on the adhesive force of the display label is concentratedly applied to the weakened portions.

With such a configuration, when a peeling-off force exceeding the adhesive force, is applied to the display label in an attempt to peel off the display label from the surface, the breaking force for breaking the weakened portions provided on the display label by cutting is concentratedly applied to the weakened portions, whereby the display label can be reliably broken at the weakened portions, irrespective of the adhesive force of the display label to the surface, and can be thus prevented from being reused. Moreover, the weakened portions are comprised of the plurality of cut lines made in the connected shape or pattern to extend in directions intersecting one another and hence, even if the direction of the peeling-off force applied to the display label, is any direction, the breaking at the weakened portions can be ensured. In addition, the weakened portions are provided at the points spaced inwards apart from the outer peripheral edge of the display label and hence, when the display label is adhered to the surface, the outer peripheral edge of the display label can be reliably adhered to the surface and thus, the display label can be affixed beautifully to the surface, notwithstanding that the display label is adapted to be easily broken.

According to a second aspect and feature of the present invention, the weakened portions are provided at the plurality of points spaced apart from one another on the display label. With such a configuration, the breaking of the display label during peeling-off can be more reliably ensured.

According to a third aspect and feature of the present invention, the display label comprises a label base having a self-adhesive applied to its back and prints provided on its surface, and a film made of a synthetic resin and covering the surface of the label base. The cut lines are formed in at least one of the label base and the film. With such a configuration, the label base made of a paper or the like can be subjected to printing to enable seal printing at a low cost in place of a screen printing at a high cost, and moreover, even if there is a reinforcing effect provided by sticking the label base and the film together, the breaking can be generated in a least one of the label base and the film during peeling-off of the display label.

According to a fourth aspect and feature of the present invention, the cut lines are formed commonly in both of the label base and the film. With such a configuration, a reinforcing effect provided by sticking the label base and the film together can be eliminated, and both the label base and the film can be broken during peeling-off of the display label.

### BRIEF DESCRIPTION OF THE DRAWINGS

FIGS. 1 to 4 show a first embodiment of the present invention.

FIG. 1 is a vertical sectional view of a display label in a state in which it has been affixed to a surface, taken along line 1-1 in FIG. 2.

FIG. 2 is a plan view of the display label.

FIG. 3 is a plan view similar to FIG. 2, showing an attempt to peel off the display label.

FIG. 4 is a plan view similar to FIG. 3, showing an attempt to peel off the display label from a direction different from that in FIG. 3.

FIG. 5 is a plan view of a display label according to a second embodiment of the present invention.

FIG. 6 is a plan view of a display label according to a third embodiment of the present invention.

### DETAILED DESCRIPTION OF THE PREFERRED EMBODIMENTS

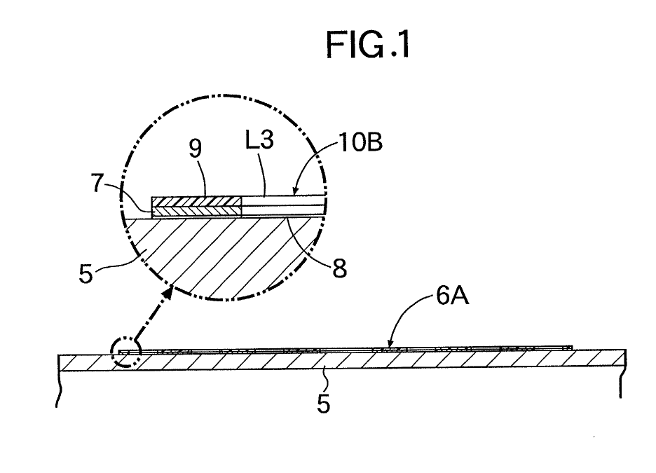

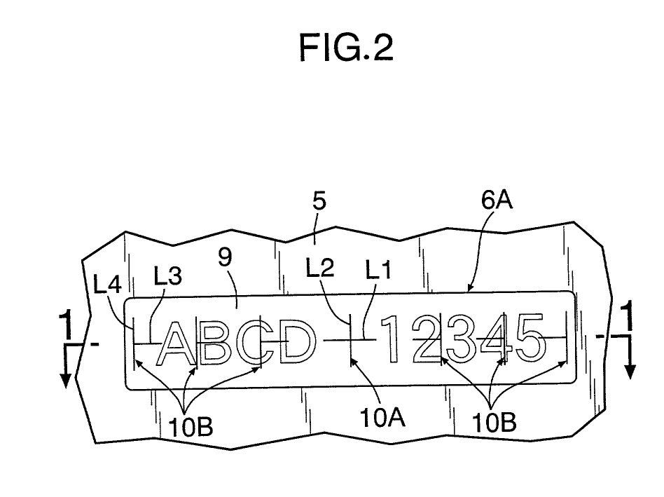

Referring first to FIGS. 1 and 2, a display label 6A such as an identifying label adapted to be adhered to a surface 5, comprises a label base 7 which is made of paper or the like, with an adhesive 8 applied to its back surface and a film 9 made of a synthetic resin covering the surface of the label base 7. Prints (represented by alphabets and numerals in FIG. 2 for simplification) are formed on the surface of the label base 7 by seal printing, and the printed section is also covered with the film 9.

The display label 6A has, a for example, arectangular shape, and includes, for example, one weakened portion 10A and six weakened portions 10B different in shape from the weakened portion 10A, which are provided thereon at a plurality of points, e.g., seven points spaced apart from one another in a lengthwise direction of the display label 6A, at locations spaced from an outer peripheral edge of the display label 6A.

The weakened portion 10A is comprised of cut lines L1 and L2 made in a cross pattern: the cut line L1 extending in the lengthwise direction of the display label 6A, and the cut line L2 extending perpendicularly to the cut line L1; and is disposed centrally in the lengthwise direction of the display label 6A.

The weakened portions 10B are each comprised of cut lines L3 and L4 made in a T-shape: the cut line L3 extending in the lengthwise direction of the display label 6A, and the cut line L4 extending perpendicularly to the cut line L3; and are disposed at three points on each of the opposite sides of the weakened portion 10A.

Moreover, each of the cut lines L1, L2, L3 and L4 is made by cutting at least one of the label base 7 and the film 9, desirably, by commonly cutting both of the label base 7 and the film 9.

The operation of the first embodiment will be described below. Provided at points spaced inwards apart from the outer peripheral edge of the display label 6A are the weakened portions 10A and 10B each comprised of the plurality of the pair of the cut lines L1 and L2; L3 and L4 made in the connected pattern to extend in directions intersecting each other.

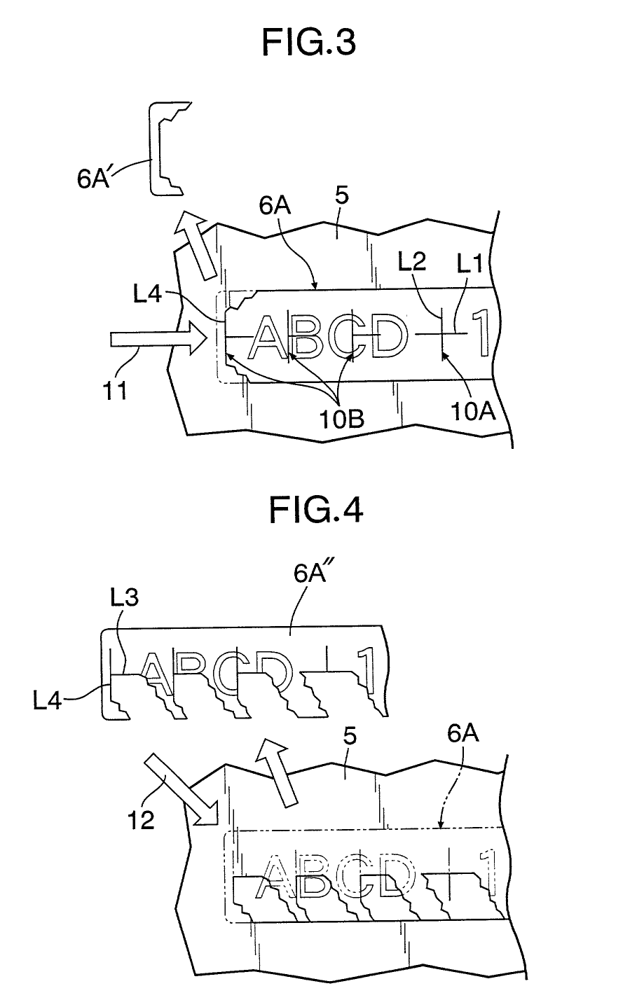

For this reason, when a peel-off force is applied to the display label 6A adhered to the surface 5, a breaking force depending on the adhesion force of the display label 6A is concentratedly applied to the weakened portions 10A and 10B. Therefore, when an attempt is made to apply the peel-off force to one end of the display label 6A from a direction 11 along the lengthwise direction of the display label 6A to peel off the display label 6A from the surface 5, as shown in FIG. 3, the breaking force for breaking the weakened portion 10B at the one end of the display label 6A is concentratedly applied to the weakened portion 10B, whereby the breaking is started from opposite ends of the cut line L4 in the weakened portion 10B and as a result, only a portion 6A′ of the display label 6A is peeled off from the surface 5. Thus, the display label 6A can be reliably broken at the weakened portion 10B, irrespective of the adhesion force of the display label 6A to the surface 5, so that it cannot be reused.

When an attempt is made to apply the peel-off force to the one end of the display label 6A from a direction 12 forming an angle with the lengthwise direction of the display label 6A to peel off the display label 6A from the surface 5, as shown in FIG. 4, the breaking force for breaking the weakened portion 10B at the one end of the display label 6A is concentratedly applied to such weakened portion 10B, whereby the breaking is started from ends of the cut lines L3 and L4 in the weakened portion 10B and as a result, only a portion 6A″ of the display label 6A is peeled off from the surface 5. Thus, the display label 6A can be reliably broken at the weakened portion 10B, irrespective of the adhesion force of the display label 6A to the surface, so that it cannot be reused.

Namely, each of the weakened portions 10A and 10B is comprised of the plurality of cut lines L1 and L2; L3 and L4 in the connected pattern to extend in the directions intersecting each other and hence, even if the direction of the peel-off force applied to the display label 6A is any direction, the breaking at the weakened portions 10A and 10B can be ensured in such a manner that the breaking is started from the end of one of the cut lines, which intersects the direction of application of the peel-off force at an angle.

The weakened portions 10A and 10B are provided at points spaced inwards apart from the outer peripheral edge of the display label 6A, and hence, when the display label 6A is adhered to the surface 5, the outer peripheral edge of the display label 6A can be reliably adhered to the surface, whereby the display label 6A can be affixed beautifully to the surface 5, notwithstanding that the display label 6A is formed in an easily broken manner.

The display label 6A is adapted to be peeled off from a release paper and put into service. Even when the label 6A is be peeled off from the release paper, the label 6A can be peeled off clearly, while avoiding the occurrence of the breaking of each of the weakened portions 10A and 10B, because the weakened portions 10A and 10B do not reach the outer peripheral edge of the display label 6A.

In addition, when the label 6A is be peeled off, the breaking of the display label 6A can be further ensured, because the weakened portions 10A and 10B are provided at a plurality of points spaced apart from one another in the display label 6A.

Further, the display label 6A is formed with the surface of the label base 7 covered with the film 9 made of the synthetic resin, and the cut lines L1, L2; L3, L4 in the weakened portions 10A and 10B are made in at least one of the label base 7 and the film 9. Therefore, the label base 7 made of paper, can be subjected to a printing to enable seal printing at a low cost in place of screen printing at a high cost, and moreover, even if there is a reinforcing effect provided by sticking the label base 7 and the film 9 together, the breaking can be produced in a least one of the label base 7 and the film 9 during peeling-off of the display label 6A.

By making the cut lines L1, L2, L3 and L4 into a structure in which they are formed commonly in both the label base 7 and the film 9, the reinforcing effect provided by sticking the label base 7 and the film 9 together can be eliminated, and both the label base 7 and the film 9 can be broken during peeling-off of the display label 6A.

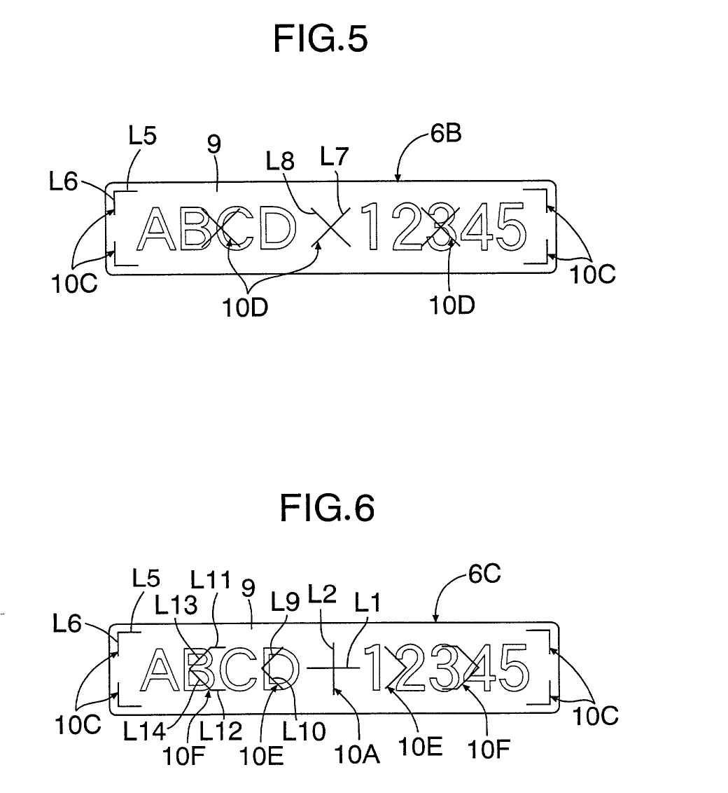

FIG. 5 shows a display label according to a second embodiment of the present invention. In this rectangular display label 6B, weakened portions 10C and 10D are provided at a plurality of, e.g., seven points spaced inwards apart from an outer peripheral edge of the display label 6B.

The weakened portions 10C are each formed into an L-shape by a cut line L5 extending in the lengthwise direction of the display label 6B, and a cut line L6 extending perpendicularly to the cut line L5, and are disposed at the four comers of the display label 6B, so that they are opened inwards to the display label 6B. The weakened portions 10D are disposed at three points spaced apart from one another in the lengthwise direction of the display label 6B, so that cut lines L7 and L8 intersect each other at right angles to form an X-shape.

With the display label 6B according to the second embodiment, a function and an effect similar to those in the first embodiment can be provided.

FIG. 6 shows a display label according to a third embodiment of the present invention. In this rectangular display label 6C, weakened portions 10A, 10C, 10E and 10F are provided at a plurality of, e.g., nine points, spaced inwards apart from an outer peripheral edge of the display label 6C.

The weakened portions 10A is disposed centrally in the lengthwise direction of the display label 6C, and the four weakened portions 10C are disposed at four corners of the display label 6C. The weakened portions 10E are disposed on opposite sides of the weakened portion 10A and each comprises cut lines L9 and L10 which are formed into a V-shape to open toward the weakened portion 10A and intersect each other. The weakened portions 10F are disposed outside the weakened portions 10E to open on opposite sides in the lengthwise direction of the display label 6C, and each comprises a pair of parallel cut lines L11 and L12 extending the lengthwise direction of the display label 6C, and cut lines L13 and L14 intersecting each other to form a V-shape and connected to the cut lines L11 and L12.

In the display label 6C according to the third embodiment, the cut lines L1, L2, L5, L6 and L9 to L14 forming the weakened portions 10A, 10C, 10E and 10F extend in many directions, as compared with those in the first and second embodiments and hence, the display label 6C can be broken more reliably during peeling-off.

As discussed above, the display label can be reliably broken at the weakened portions, irrespective of the adhesive force of the display label to the surface, and thus prevented from being reused. Moreover, even if the direction of the peeling-off applied to the display label is any direction, the breaking at each of the weakened portions can be ensured in such a manner that the breaking is started from an end of one of the cut lines, which intersects the direction of force applied at an angle. In addition, the display label can be affixed beautifully, notwithstanding that the display label is adapted to be broken easily.

Further, the breaking of the display label during peeling-off can be more reliably ensured.

Also, even if there is a reinforcing effect provided by sticking the label base and the film together, the breaking can be produced in at least one of the label base and the film during peeling-off of the display label.

Still further, the reinforcing effect provided by sticking the label base and the film together can be eliminated, and both of the label base and the film can be broken during peeling-off of the display label.

The present invention may be embodied in other specific forms without departing from the spirit or essential characteristics thereof. The presently disclosed embodiments are therefore to be considered in all respects as illustrative and not restrictive, the scope of the invention being indicated by the appended claims, rather than the foregoing description, and all changes which come within the meaning and range of equivalency of the claims are, therefore, to be embraced therein.

1. A peel-off/break structure of a display label which has prints on its surface and a self-adhesive applied on its back, comprising a weakened portion comprising a plurality of cut lines formed in a connected pattern in directions to intersect one another, the cut lines being spaced inwards from the outer peripheral edge of the display label, wherein when a peeling-off force is applied to the display label adhered to a surface, a breaking force is concentratedly applied to the weakened portion.

2. A peel-off/break structure of a display label according to claim 1, wherein the weakened portion is formed at each of a plurality of points spaced from one another on the display label.

3. A peel-off/break structure of a display label according to claim 1 or 2, wherein the display label comprises a label base having prints on its surface and a self-adhesive applied on its back, and a film made of a synthetic resin and covering the surface of the label base, the cut lines being formed in at least one of the label base and the film.

4. A peel-off/break structure of a display label according to claim 1 or 2, wherein the cut lines are formed in both the label base and the film.

5. A peel-off/break structure of a display label comprising a label base, a film on the label base and a plurality of weakened portions each comprising a plurality of cut lines formed in a connected pattern in directions to intersect one another, the cut lines being formed in at least one of the label base and the film at points spaced inwards from the outer peripheral edge of the display label, wherein when a peeling-off force is applied to the display label adhered to a surface, a breaking force is concentratedly applied to the weakened portions.

6. A peel-off/break structure as set forth in claim 5, wherein at least one of the plurality of weakened portions comprises a T-shaped pattern.

7. A peel-off/break structure as set forth in claim 5, wherein at least one of the plurality weakened portions comprises two perpendicularly crossed lines.

8. A peel-off/break structure as set forth in claim 5, wherein at least one of the plurality of weakened portions comprises two lines forming a V-shape.

9. A peel-off/break structure as set forth in claim 5, wherein at least one of the plurality of weakened portions comprises two lines forming a [symbol] -shape.
